(19) United States
(12) Patent Application Publication
(10) Pub. No.: US 2025/0044092 A1
(43) Pub. Date: Feb. 6, 2025

(54) COLD-ATOM SENSOR OF GYROMETER TYPE WITH BIAS CORRECTED

(71) Applicant: THALES, MEUDON (FR)

(72) Inventors: Benjamin WIRTSCHAFTER, PALAISEAU (FR); Matthieu DUPONT-NIVET, PALAISEAU (FR); Soizic HELLO, Châtellerault (FR)

(21) Appl. No.: 18/792,323

(22) Filed: Aug. 1, 2024

(30) Foreign Application Priority Data
Aug. 3, 2023 (FR) 2308409

(51) Int. Cl. G01C 19/64

(52) U.S. Cl. CPC G01C 19/64

(57) ABSTRACT

An interferometric inertial ultracold-atom sensor of gyrometer type, including an atom chip comprising at least one set of a first and second elementary sensor, a power-supplying device, the magnetic-field generator and the power-supplying device being configured to apply the magnetic field, the DC currents and the microwave signals in a predetermined sequence, the arrangement of the group of one or more conductive elements of each sensor and the sequence further being configured so that the path associated with the first elementary sensor and the path associated with the second elementary sensor are identical and traced simultaneously and in inverse directions by the clouds of ultracold atoms associated with a given internal state, the sensor further comprising a detecting system.

### CROSS-REFERENCE TO RELATED APPLICATION

This application claims priority to foreign French patent application No. FR 2308409, filed on Aug. 3, 2023, the disclosure of which is incorporated by reference in its entirety.

### FIELD OF THE INVENTION

The present invention relates to the field of inertial sensors and more specifically of interferometric inertial cold-atom sensors integrated into an atom chip. More particularly, the invention relates to on-atom-chip cold-atom sensors of gyrometer type using microwave fields and where appropriate DC currents to spatially separate and move the two clouds of atoms in two internal states, used during measurement of inertial parameters (typically velocity of rotation).

### BACKGROUND

Generally, inertial sensors are devices that make it possible to measure movement-related physical parameters, such as accelerations or angular velocities, that, when associated with a clock, allow spatial position to be determined. A device that measures acceleration and velocity of rotation is known as an inertial measurement unit (IMU).

On-chip cold-atom interferometry technology allows this type of inertial measurement to be carried out, and tends to be compact enough and to perform well enough to be used in embedded applications.

Operation of cold-atom gyrometers is based on interferometry, and measuring the phase difference of the interferometer allows a measurement of rotation to be obtained.

In a cold-atom interferometer two electron states, namely a first internal state |a> and a second internal state |b> of an atom, such as rubidium 87, are made to interfere in a Ramsey sequence. A Ramsey interferometer sequence measures a phase φ accumulated during implementation of the sequence, via a measurement of at least one population of a chosen state |a> or |b> (preferably a measurement of both populations for greater precision).

To make such an interferometer sensitive to rotations, the two states both have to trace a closed path bounding a non-zero area, and to do so in opposite directions for |a> and |b>. A term dependent on the Sagnac effect, and therefore on velocity of rotation, is thus added to the energy difference between the two states.

A brief recapitulation will be provided below of the operating principle of measurement of rotation by interferometry, based on a Ramsey sequence of clock type, where the phase of the interferometer at the end of the sequence is proportional to the energy difference between the two states of the interferometer.

In the case of a clock, the phase of the interferometer is given by:

$${φ}_{c l o c k} = {φ}_{a} - {φ}_{b} = ( ω - {ω}_{a b} ) {T}_{R}$$

with:

$${ω}_{a b} = {ω}_{0 a} - {ω}_{0 b}$$

φₐ is the phase of atoms in state |a>, and φ_{b} that of the atoms in state |b>,
ω is the angular frequency of the local oscillator,
ℏω₀ₐ is the electron energy of level |a> and hoop is the electron energy of level |b>.
ω_{ab} is the angular frequency corresponding to the energy difference between the states |a> and |b>, and T_{R} is the free evolution time (Ramsey time).

If during this sequence, it is made so that the atoms in state |a> and those in state |b> each trace in opposite directions the same closed path containing a non-zero area, a term describing a phase shift sensitive to rotations about the normal to this area appears due to the Sagnac effect: the clock becomes a gyrometer.

If the path of state |a> describes, for example, a rectangle traced clockwise, and state |b> describes the same path but anti-clockwise, then this phase shift is given by:

$${φ}_{r o t} = {φ}_{a} - {φ}_{b} = \frac{m}{ℏ} {\int }_{0}^{{T}_{R}} [ {Ω}_{z} ( {r}_{a} ∧ {ν}_{a} ) + {( {Ω}_{z} ∧ {r}_{a} )}^{2} + a \cdot {r}_{a} ] d t - \frac{m}{ℏ} {\int }_{0}^{{T}_{R}} [ {Ω}_{z} ( {r}_{b} ∧ {ν}_{b} ) + {( {Ω}_{z} ∧ {r}_{b} )}^{2} + a \cdot {r}_{b} ] d t$$

where Ω_{z} is the angular velocity about the z-axis, rₐ and vₐ (r_{b} and v_{b}, respectively) are the position and the velocity of the atoms in state |a> (state |b>, respectively) in the reference frame tied to the sensor and a is an acceleration undergone by the sensor, which acceleration is directed along the axis of separation of the two states and is measurable. m is the mass of the atom and h is the reduced Planck constant.

For a path forming a loop such that each state returns to its initial position at the end of the sequence, it may be shown that, if a is constant, the terms in a·r are equal to 0 and that the terms (Ω_{z}∧rₐ)² and (Ω_{z}∧r_{b})² cancel out. The phase shift may then be written in the form (in the case where Ω_{z} is constant during T_{R}):

$${φ}_{rot =} = \frac{m}{ℏ} {\int }_{0}^{{T}_{R}} {Ω}_{z} ( {r}_{a} ∧ {ν}_{a} - {r}_{b} ∧ {ν}_{b} ) d t = \frac{4 m N {Ω}_{z} \cdot A}{ℏ} {T}_{R}$$

where A is a vector normal to the area described by the paths of the two states and the norm of which is equal to the area and Nis the complete number of revolutions traced by each state.

The total phase output by the interferometer at the end of the sequence is therefore:

$${φ}_{tot} = {φ}_{clock} + {φ}_{rot} = ( ω - {ω}_{a b} + \frac{4 m N {Ω}_{z} \cdot A}{ℏ} ) {T}_{R} \qquad ( 1 )$$

Knowledge of this phase φₜₒₜ and of the other quantities and parameters of formula (1) makes it possible to determine the velocity of rotation about the z-axis perpendicular to the plane of the path.

The operating principle of an atom-chip-based ultracold-atom gyrometer making it possible to generate the clouds of ultracold atoms and the paths allowing the velocity of rotation to be measured via phase such as described above will be recapitulated below.

Ultracold atoms are defined to be atoms the temperature of which is lower than 400 nanokelvins, and preferably lower than 300 nanokelvins. The temperature of thermal ultracold atoms is, for example for rubidium atoms, between 50 and 400 nanokelvins and preferably between 100 and 300 nanokelvins.

The principle is to get a path to be traced by two counter-propagating clouds of magnetically trapped atoms. The creation of the magnetic trap and its movement along the path are achieved via conductive wires/elements and microwave guides placed on and in the atom chip.

Various conductive-element and waveguide topologies are known to those skilled in the art.

A first example, illustrated in FIG. 1, is described in document US2018/0352642.

The surface of the chip defines an XY-plane or measurement plane, normal to a Z-axis.

The chip 1 comprises means suitable for generating a first ultracold-atom trap T1 and a second ultracold-atom trap T2, a trap allowing a cloud of ultracold atoms 12 to be immobilized in an internal state different from the other trap, at a predetermined distance h from said measurement plane 13. For example, the trap T1 comprises atoms in the electron level or state |a> (cloud CL1) and the trap T2 comprises atoms in the state |b> (cloud CL2). The levels |a> and |b> are separated by a frequency ω_{ab}/2π. For example, in the case of rubidium 87 it is a question of the two hyperfine levels |F=1, m_{-F}=−1> and |F=2, m^{-F}=1>, which are separated by about 6.8 GHz.

These means also allow the clouds to be moved along the path 16 (also denoted TZ) located in a plane parallel to the measurement plane 13, at a height h from this plane, such as illustrated in FIG. 1. These means consist of waveguides and conductive wires.

The waveguides CPW1 and CPW2 are suitable for propagating microwaves at angular frequencies ω_{b} and ωₐ. The waveguides are arranged symmetrically, preferably parallel, with respect to a Y-axis of the measurement plane. The two waveguides CPW1 and CPW2 are connected to at least one generator for generating voltage or current at microwave frequencies. For example, each of the waveguides is produced by depositing three conductive wires parallel so as to form a coplanar waveguide. In other embodiments, other types of waveguides may be used, in particular waveguides production of which is compatible with microfabrication techniques employing deposition or etching. It is possible, for example, to produce a microstrip line.

The conductive wires integrated into the chip 1 are able to pass DC currents. The conductive wires are assorted into a conductive wire Wlz along an axis of symmetry Y perpendicular to X and contained in the measurement plane 13, and into a plurality of n conductive wires Wldi, the index i varying from 1 to n, that are mutually parallel and parallel to the X axis, n being at least equal to 2. In the example of FIG. 1, n=3, i.e. there are three conductive wires Wld1, Wld2 and Wld3. The wires are arranged so as to define n crossing points Ci (crossing between Wlz and Wldi) located on the Y-axis, here 3 crossing points C1, C2, C3.

Each conductive wire is connected to one or more current and/or voltage generators, themselves connected to a processing unit comprising at least one microprocessor. The voltage and/or current generators allow both DC currents and AC currents to be driven through the wires. In particular, DC currents are driven through the conductive wires.

In the sensor, the atom chip 1 is placed in a vacuum chamber the vacuum of which is for example maintained using an ion pump and that preferably comprises magnetic shielding. The sensor comprises a device for generating ultracold atoms, which comprises:
an atom dispenser, for example a heated filament that delivers a rubidium vapor;
a primary (optical and/or magnetic) atom trap, allowing a cloud of ultracold atoms to be pre-cooled and localized in the vicinity of the chip, with a view to loading the magnetic traps T1 and T2 described below with atoms.

The sensor also comprises a magnetic-field source, external to the chip 1. It allows a uniform and static magnetic field Bc to be generated over a thickness at least of the order of a height h above the measurement plane 13. Advantageously, the direction of the uniform magnetic field is parallel to the measurement plane.

In FIG. 1, the path 16 shown by the dotted lines illustrates the path of the clouds of ultracold atoms 12. This closed path defines an area denoted A. A distance h separates the plane of the path 16 and the measurement plane 13 of the chip. Preferably, h is between 500 nm and 1 mm, and preferably between 5 μm and 500 μm.

FIG. 2 illustrates the geometry of the guides and wires of the atom chip as well as the traps T1 and T2. The specific arrangement of the conductive wires and of the waveguides, in association with the uniform magnetic field of the source, makes it possible to easily obtain two traps T1 and T2 as illustrated in the part a) of FIG. 2. Each trap T1 and T2 has the same non-zero minimum value V0, and an identical curvature, a necessary condition for the sensor to operate. Specifically, when a DC current is applied to at least two conductive wires of a crossing point, the minimum of the potential is located plumb with this crossing point. When microwave power is then sent through the waveguides, the central minimum is converted into two minima that are located on either side of the initial minimum in the direction of the waveguides. If the initial minimum is not located strictly at equal distance from the two waveguides, the two potential minima created will not have strictly the same minimum value V0 and the same curvature.

Part c) of FIG. 2 illustrates the layout of the conductive wires defining the initial crossing point C1 and of the waveguides (seen from above). Part b) of FIG. 2 illustrates a profile view of the corresponding layout of the conductive wires and of the waveguides printed on a chip, the view being of a cross section through the conductive wire Wld1, which intersects the conductive wire Wlz along the axis of symmetry Y. The waveguides CPW1 and CPW2 are coplanar waveguides located in a first level N1. The insulating layer 18 advantageously allows the measurement plane to be flattened. The material of the electrically insulating layer may for example be silicon dioxide, silicon nitride or benzocyclobutene. A conductive material, gold for example, is used to manufacture the conductive wires, and is deposited on a substrate 15, forming a second level N2. The substrate may for example be made of silicon, of aluminium nitride or of silicon carbide.

Part a) shows the symmetrical separation of ultracold atoms, which is specific to the internal state of the ultracold atoms, and more precisely the variations in potential as a function of position on the X-axis of the chip 1.

Curve “a” shows a potential well corresponding to the association of the uniform magnetic field and of the field created by two secant conductive wires—the wire Wlz passing a current I_{Z} and the wire Wld1 passing a current I_{d1}. A local potential well (initial potential Vini) forming a three-dimensional atom trap T results. A cloud of ultracold atoms may be trapped therein and cooled.

Curve “b” schematically shows the potential created by the transmission of microwaves at the frequency ω_{b} through the waveguide CPW1. The field emitted by the passage of microwaves at the frequency ω_{b} allows the energy of the ultracold atoms to be modified and the atoms of internal states |b> to be moved. Curve “e” illustrates the potential seen by the internal states |b> as a result of the contributions of the potentials illustrated by curve “a” and by curve “b”. Curve “e” has a local potential minimum allowing a cloud of ultracold atoms of internal states |b> to be trapped locally.

Similarly, curve “d” schematically shows the potential created by the transmission of microwaves at the frequency ωₐ through the waveguide CPW2. The field emitted by the passage of microwaves at the frequency ωₐ allows the energy of the ultracold atoms to be modified and the atoms of internal states |a> to be moved. Curve “c” illustrates the potential seen by the atoms of internal states |a> as a result of the contributions of the potentials illustrated by curve “a” and by curve “d”. Curve “c” has a local energy minimum allowing a cloud of ultracold atoms of internal states |a> to be trapped locally.

The association of a DC magnetic trap (created by the DC currents in the wires and the uniform field Bc) and of a microwave field creates what is called a “dressed” trap. The term “dressed” is understood to mean a trap created at least in part by a microwave, radiofrequency or optical oscillating field. The changes in microwave fields (power, frequency and guide in which they propagate) make it possible to move this dressed trap, and therefore to move the atoms. The DC magnetic trap is represented in FIG. 2 by curve a. The microwave field at ωₐ is represented in FIG. 2 by curve d and the microwave field at ω_{b} is represented in FIG. 2 by curve b. The dressed trap T1 (association of curves a and d) for the state |a> is represented by curve c and the dressed trap T2 (association of curves a and b) for the state |b> is represented by curve e.

Clouds of ultracold atoms of internal states |a> and |b> may be separated and trapped symmetrically with respect to the axis of symmetry Y by simultaneously making waves of frequency ωₐ propagate through CPW2 and waves of frequency ω_{b} propagate through CPW1. To obtain two traps the minima of which are of the same value V0 and the curvatures of which are of the same value, it is important for the crossing point C1 to be placed at an equal distance from CPW1 and CPW2, on the axis of symmetry Y.

The frequencies ωₐ and ω_{b} are chosen depending on the frequencies of the states |a> and |b>ω₀ₐ and ω_{0b}.

FIG. 3 illustrates the principle of generation of the path 16. Part a) of FIG. 3 schematically shows a sequence of the movement of each of the clouds of ultracold atoms at characteristic times t₁ to t₉. Part b) illustrates, in a complementary manner, a sequence of the various currents applied to the conductive wires, of the powers applied to the waveguides and of the frequencies applied to the waveguides, at the times corresponding to the times of part a).

In the sequence presented in FIG. 3, the current I_{z} (not shown) flowing through Wlz is static and at a constant value. In part b), the values of the currents, of the powers and of the frequencies are arbitrary values. The y axis labelled δ frequency corresponds to a frequency variation expressed in arbitrary units about an average frequency value. The currents passing through the conductive wires may be between 100 μA and 10 A, and the angular frequencies injected into the waveguides may be between 6.6 GHz and 7 GHz in the case of use of rubidium atoms.

In a step A0, there is a phase of preparing the atoms. A cloud of ultracold atoms 12 is generated, this including phases of dispensing said atoms, of cooling said atoms, of initializing said atoms to at least one internal state |a> and of trapping a cloud of said ultracold atoms in a local potential minimum, at a distance h from the measurement plane (trap T, curve “a” of FIG. 2 part a)). The height h is different from 0 because the uniform magnetic field Bc is non-zero.

Trapping is achieved by passing DC currents through the wire Wlz and through one of the wires Wldi, the crossing point of these two wires defining the start point (here C1 with Wld1). At the same time, a bias magnetic field Bc is applied parallel to the plane of the atom chip, which field superposes on the magnetic field created by the preceding two wires. The cloud of atoms is then trapped by the potential Vini plumb with C1, the intersection of the wires Wlz and Wld1.

In a step B0, the internal states are initialized by coherently superposing the ultracold atoms in the states |a> and |b> via a first pulse π/2. This pulse may be produced by a laser, a microwave emitter, or more generally using a method whereby waves are emitted at a suitable transition frequency. Currents I_{Z} and Idi are applied to the conductive wires Wlz and Wld1, respectively. The two internal states |a> and |b> are superposed coherently and spatially plumb with the crossing point C1.

In a step C0, a cloud of atoms of internal state |a> in one trap T1 is spatially separated from a cloud of atoms of internal state |b> in another trap T2, and the traps are moved in opposite directions along a closed path 16 contained in a plane perpendicular to the measurement axis Z. The cloud of atoms of internal states |a> has been symbolized by a disc of light texture, and the cloud of atoms of internal states |b> has been symbolized by a disc of darker texture. This step is carried out in the example of FIG. 3 from t₁ to t₉.

Between t₁ and t₂, the microwave power injected into the waveguides CPW1 and CPW2 gradually changes from 0 to its maximum value. An angular frequency ω_{b} is sent to the waveguide CPW1 and an angular frequency ωₐ is sent to the waveguide CPW2, this allowing the two clouds of different internal states to be moved either side of the axis of symmetry Y, by a distance d, to the positions schematically shown for t₂. The ultracold-atom trap T described above at the time t₁ is thus converted into two ultracold-atom traps T1 and T2, each trap allowing a cloud of ultracold atoms of internal states different from the other trap to be immobilized (in the present case, internal states |a> in one of the traps, for example T1, and internal states |b> in the other trap T2, as described in part a) of FIG. 2).

A crossing point Ci corresponds to the crossing of the wire Wlz with the wire Wldi.

Between t₂ and t₃, the current I_{d1} is gradually cut and I_{d2} is gradually brought to its maximum value (the time interval separating t₂ and t₃ is typically of the order of 10 ms and may be between 0.1 ms and 100 ms): the two traps T1 and T2 are moved to the right to the positions schematically shown for t₃.

Between t₃ and t₄, the current I_{d2} is gradually cut and las is gradually brought to its maximum value: the two traps are moved to the right to the positions schematically shown for t₄.

Between t₄ and t₅, the microwave power is gradually cut: the two traps are brought back to the same place on the chip, as schematically shown for t₅.

At t₅, the angular frequencies of the two microwave guides are modified: the angular frequency ωₐ is applied to CPW1 and the angular frequency ω_{b} is applied to CPW2.

Between t₅ and t₆, the power in the two waveguides gradually changes from 0 to its maximum value: the traps are separated in the vertical direction as schematically shown in the figure for t₆.

Between t₆ and t₇, the current las is gradually cut and I_{d2} is gradually brought to its maximum value: the two traps T1 and T2 are moved to the left to the positions schematically shown for t₇.

Between t₇ and t₈, the current I_{d2} is gradually cut and Idi is gradually brought to its maximum value: the two traps are moved to the left to the positions schematically shown for t₈. This operation may be repeated a number of times with other first conductive wires to increase the area enclosed by the path 16.

Between t₈ and t₉, the microwave power in the waveguides is gradually cut. The two traps T1 and T2 move until they merge into a single trap located at the start point schematically shown for t₁.

DC currents are thus applied to the two wires corresponding to the initial crossing point C1, and over time these currents are successively applied to the various crossing points Ci located on the axis of symmetry, while simultaneously applying microwave power to the waveguides.

During step C0, the DC currents applied to the various wires Wldi constantly vary (increase and decrease) between 0 and a maximum value Idimax (normalized to 1 in FIG. 3), whereas the magnetic field Bc and the current Iz remain constant during the sequence. Throughout the sequence A0, B0 and C0, the two traps T1 and T2 remain at the height h.

The two traps T1 and T2 move in the direction of “turn-on” of the crossing points: from the crossing point C1 to the crossing point Cn. The return trip is made by inverting the microwave frequencies and turning on the DC currents successively in the wires corresponding to the various crossing points, passing through them from Cn to C1. The traps are thus made to travel the closed path 16.

In a step D0, the internal states |a> and |b> are recombined by applying a second pulse π/2 to the ultracold atoms, this transferring the phase difference to the populations of the two atomic levels. Next, the density of atoms in an internal state chosen from at least |a> and |b> is measured.

Lastly, in a step E0, the Sagnac phase shift of the ultracold atoms (interferometer phase shift) is determined and the velocity of rotation of the sensor about the Z-axis is computed.

To measure a velocity of rotation about an axis, it is necessary to generate a path in a plane perpendicular to this axis.

A second example of chip topology, illustrated in FIG. 4, is described in document US2023/0178262.

The atom chip comprises a first pair of waveguides (CPWX1, CPWX2) that are parallel to each other and that are placed symmetrically with respect to an X-axis, and a second pair of waveguides (CPWY′1, CPWY′2) that are parallel to each other and that are placed symmetrically with respect to a Y′-axis, which in this non-limiting example is perpendicular to X and equal to the Y-axis. The Y′-axis is different from the X axis, and the two pairs of guides are secant and define a parallelogram. The chip also comprises two conductive wires W1 and W2 that cross at the point O. When the two wires pass a DC current they generate the potential Vini, which has a minimum at the point O. The starting cloud CL is thus trapped above the point O. For reasons of symmetry, the point O preferably coincides with the centre of the parallelogram.

In this document, the produced paths are perpendicular to X (path TX) and Y (paths TY). To measure the velocity of rotation Ωx about the X-axis, the path TX is generated via the waveguides, the conductive wires and the field B0. Likewise, to measure the velocity of rotation Ωy′ about the Y′-axis, a path TY′ is generated via the waveguides, the conductive wires and the field B0.

The movement made by the atoms taking path TX is illustrated in FIG. 5. The Ramsey sequence starts at t0 (DC currents are applied to the two conductive wires W1 and W2 to generate Vini). At t1 the clouds are separated, the two clouds being separated in a manner identical to that described in document US2018/0352642 (application of microwave signals to the guides). At t2, the clouds CL1 and CL2 are “raised” from a height h1 to a height h2 by modifying the value of the current flowing through the wires and/or by modifying the value of the field B0. A substantially vertical segment of the path is then traced, over a distance w=h2−h1 (see the cited document for one example of a timing diagram describing the sequence of application of the various signals). Next, at t3 the two clouds are brought back to the X-axis, still at the height h2, by gradually decreasing the power applied to the waveguides to zero. The other portion of the second path segment at h2 on the other side of the X-axis (t4, t5) is obtained by inverting the values of the frequencies of the microwaves applied to the guides CPWX1 and CPWX2. At t5, the height h1 is returned to by returning the currents flowing through the conductive wires to the initial values and/or by returning the magnetic field to its initial value. Lastly, at t6, the microwave power applied to the guides is decreased to zero and the two clouds meet.

The geometry of the chip of document US2018/0352642 may be combined with that of document US2023/0178262 by integrating additional wires defining crossing points inside the parallelogram defined by the guides. An interferometric inertial sensor is thus produced that allows measurement of three velocities of rotation Ωx, Ωy and Ωz.

The document US2023/0178262 describes production of a matrix-array chip AchM0 allowing a plurality of elementary sensors to be produced. FIG. 6 illustrates an example of a 6×6 matrix array. The waveguides, which extend along 6 axes Xn and along 6 axes Ym, form the columns and rows of the matrix array (in another geometry described in the cited document the waveguides form diagonals). Each pixel (n,m) of the matrix array corresponds to one potential elementary sensor. For example, the chips of column C1 measure ax, the chips of column C2 measure Ωy, the chips of row L1 measure ay and the chips of row L2 measure Ωx. As a measurement requires a particular sequence of the coplanar guides, the latter cannot be shared in two simultaneous measurements of two distinct inertial parameters. Thus the pixels 4 encircled by a circle are not used. The matrix-array chip is thus reconfigured as required: the desired type of measurement (ax, ay, Ωx, Ωy, t), the desired accuracy (which depends on the number of chips simultaneously making the measurement), etc. Parallel, redundant and/or complementary measurements are thus carried out on the same matrix-array chip.

According to another atom-chip geometry described in document US2022/0397396, paths are produced along the three axes using additional pairs of waveguides and a flared conductive wire defining a DC plane. Particular sequences of microwave signals are applied to the various pairs, including signals at a frequency ωa, a frequency ωb and signals including both frequencies, which signal is denoted ωa+ωb and called the “sum” signal. One effect of applying a “sum” signal (signal resulting from summing a signal of frequency ωa and a signal of frequency ωb) is to repel the two clouds to the side opposite the one on which the guide through which this signal is flowing is located, to produce a path for measuring a velocity of rotation about the Z-axis (see for example FIGS. 16 to 18 of the cited document). The cited document also describes passage from a height h1 to a height h2 when two guides placed on either side of the clouds are simultaneously traversed by the “sum” signal, to produce paths for measuring a velocity of rotation about the X- and Y-axes (see for example FIGS. 20 and 22 of the cited document).

Another chip geometry is described in document US2022/0397397, which geometry comprises two secant conductive strips, the intersection of which is at least partly contained in the parallelogram defined by the two pairs of waveguides. The paths are produced by applying a specific sequence of microwave signals to the guides, also using the “repelling” effect of “sum” signals.

The preceding two chip geometries are also compatible with a matrix-array architecture.

To obtain a more accurate measurement of a rotation about a certain axis, it is possible to exploit measurement redundancy (use of a plurality of sensors, for example a matrix-array architecture of sensors such as described above).

Thus, a sensor based on a matrix-array chip comprising a plurality of elementary sensors in the various geometries described above allows:
the clock function, measurement of acceleration along two orthogonal axes and measurement of rotations about three pairwise-orthogonal axes to be performed on a single chip,
the elementary geometry to be duplicated on the same atom chip in order to make all the aforementioned measurements in parallel and to achieve redundancy between the various measurements.

However, this solution does not allow measurement bias to be eliminated or errors to be corrected.

Every measurement has an associated uncertainty, which is expressed by an error in the measurement. This error may be due to random factors that are unavoidable and that cannot be corrected (although their magnitude may be estimated), but also to systematic factors due to sensor imperfections or imperfect measurement conditions. This latter type of error is also known as bias.

### SUMMARY OF THE INVENTION

One aim of the present invention is to overcome the aforementioned drawbacks by providing an inertial sensor and measuring method allowing certain biases to be corrected, in order to obtain a better sensor performance.

One subject of the present invention is an interferometric inertial ultracold-atom sensor of gyrometer type comprising:
an atom chip placed in a vacuum chamber, comprising an XY-plane, called the measurement plane, normal to a Z-axis, and comprising at least one set of a first and a second elementary sensor, each elementary sensor comprising:
at least one first pair of waveguides parallel to each other and at least one second pair of waveguides parallel to each other and secant with the first pair,
a group of one or more conductive elements,
an atom-generating device configured to generate an initial cloud of ultracold atoms associated with the first elementary sensor and an initial cloud of ultracold atoms associated with the second elementary sensor, said initial clouds being located close to said XY-plane of said chip,
   a generator for generating a uniform magnetic field,
   a power-supplying device comprising at least one microwave generator and at least one generator of DC current, the power-supplying device being configured to apply microwave signals to said waveguides and DC currents to said conductive elements,
   the magnetic-field generator and the power-supplying device being configured to apply the magnetic field, the DC currents and the microwave signals in a predetermined sequence,
   an arrangement of said group of one or more conductive elements and said sequence being configured, during implementation of each sensor, to:
   generate an initial potential for trapping said initial cloud of ultracold atoms,
   spatially separate the initial cloud into a first cloud of ultracold atoms in a first internal state and a second cloud of ultracold atoms in a second internal state, by forming a first ultracold-atom trap and a second ultracold-atom trap, respectively,
   and move said traps along a closed path parallel or perpendicular to XY, said closed path being traced in one direction by the first cloud of ultracold atoms and in the opposite direction by the second cloud of ultracold atoms,
   the arrangement of said group of one or more conductive elements of each sensor and said sequence further being configured so that the path associated with the first elementary sensor and the path associated with the second elementary sensor are identical and traced simultaneously and in inverse directions by the clouds of ultracold atoms associated with a given internal state,
   the sensor further comprising a detecting system configured to measure at least a first phase of the first elementary sensor and a second phase of the second elementary sensor, with a velocity of rotation being determined from a difference between the first and second phases.

According to one embodiment, the power-supplying device is further configured to apply DC currents to said waveguides.

According to one embodiment, the sensor according to the invention comprises at least three sets configured to make a measurement of rotation about three orthogonal axes, respectively.

According to one embodiment, the atom chip has a matrix-array structure, the pixels of which define potential elementary sensors, a set comprising two pixels of the matrix array.

According to one embodiment, sets of a first and second elementary sensor have a pair of waveguides in common or at least one conductive element in common.

According to another aspect the invention relates to an inertial measurement unit comprising at least three sensors of gyrometer type according to the invention, which sensors are configured to make a measurement of velocity of rotation about three orthogonal axes respectively, the matrix-array atom chip further comprising pixels configured to make at least one clock measurement and pixels configured to make a measurement of acceleration along at least two orthogonal axes.

According to another aspect, the invention relates to a method for measuring a velocity of rotation using an interferometric inertial ultracold-atom sensor comprising an atom chip placed in a vacuum chamber, comprising an XY-plane, called the measurement plane, normal to a Z-axis, and comprising at least one set of a first and second elementary sensor, each elementary sensor comprising:
at least one first pair of waveguides parallel to each other and at least one second pair of waveguides,
a group of one or more conductive elements,

the method comprising the following steps:

A. generating an initial cloud of ultracold atoms associated with the first elementary sensor and an initial cloud of ultracold atoms associated with the second elementary sensor, said initial clouds being located close to said XY-plane of said chip,

B. generating a uniform magnetic field,

C. generating an initial potential for trapping said initial cloud of ultracold atoms,

D. for each sensor, initializing a first internal state and a second internal state via a first π/2 pulse,

E. for each sensor, spatially separating the initial cloud into a first cloud of ultracold atoms in the first internal state and into a second cloud of ultracold atoms in the second internal state, by forming a first ultracold-atom trap and a second ultracold-atom trap, respectively,

F. for each sensor, moving said traps along a closed path parallel or perpendicular to XY, said closed path being traced in one direction by the first cloud of ultracold atoms and in the opposite direction by the second cloud of ultracold atoms, steps B to F being carried out by applying, in a predetermined sequence, a uniform magnetic field, DC currents to said conductive elements and microwave signals to said waveguides,
the arrangement of said group of elements of one or more conductive elements and said predetermined sequence further being configured so that the path associated with the first elementary sensor and the path associated with the second elementary sensor are identical and traced simultaneously and in inverse directions by the clouds of ultracold atoms associated with a given internal state,

G. recombining said first and second internal states by applying a second π/2 pulse to said ultracold atoms,

H. measuring at least a first phase of the first elementary sensor and a second phase of the second elementary sensor, a velocity of rotation being determined from a difference between the first and second phases.

According to one embodiment, step C comprises applying DC currents to at least one conductive element.

According to one embodiment, step E comprises applying microwave signals to the first pair of waveguides.

According to one embodiment, step F comprises applying microwave signals to at least one waveguide of the second pair.

According to one embodiment, step F comprises applying DC currents to certain conductive elements.

The following description presents a number of examples of embodiment of the device of the invention: these examples do not limit the scope of the invention. These examples of embodiments contain not just features that are essential to the invention but also additional features associated with the embodiments in question.

### BRIEF DESCRIPTION OF THE DRAWINGS

The invention will be better understood and other features, aims and advantages thereof will become apparent from the following detailed description, which is given with reference to the appended drawings, which are given by way of non-limiting example and in which:

FIG. 1 (already described) illustrates a first example of the topology of an atom chip according to the prior art.

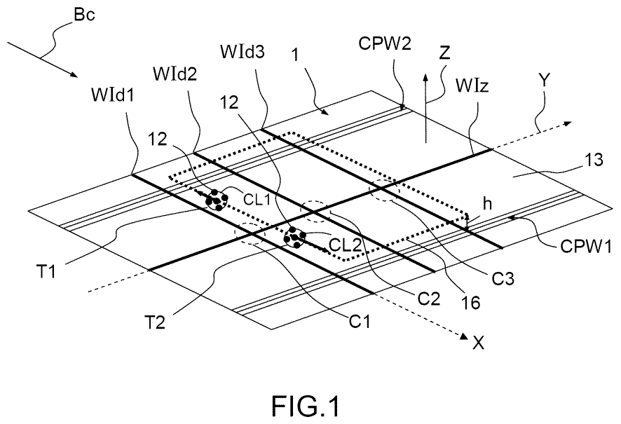

FIG. 2 (already described) illustrates the geometry of the guides and wires of the atom chip and the ultracold-atom traps and associated potentials according to the prior art.

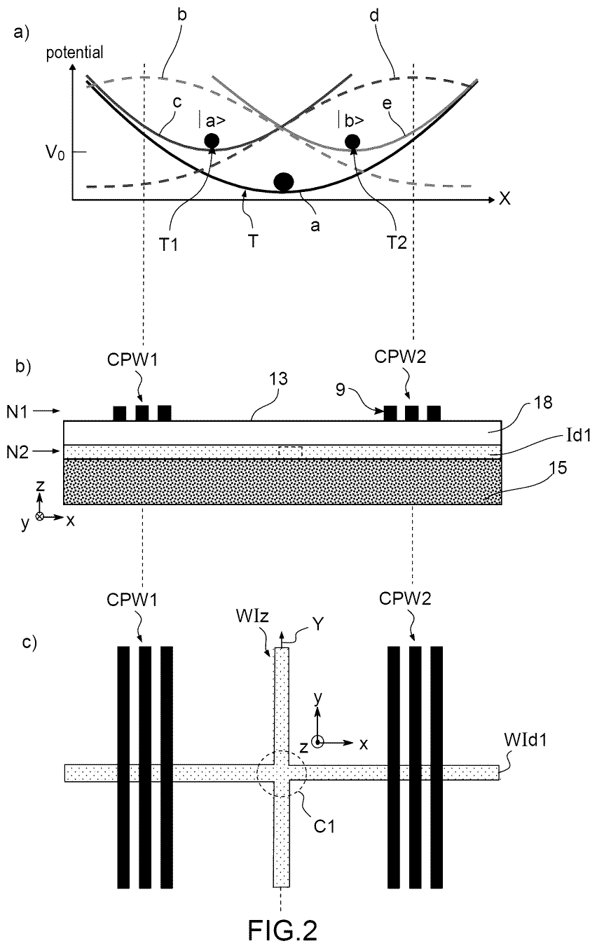

FIG. 3 (already described) illustrates the principle of path generation. Part a) schematically shows a sequence of the movement of each of the clouds of ultracold atoms at characteristic times t₁ to t₉. Part b) illustrates, in a complementary manner, a sequence of the various currents applied to the conductive wires, of the powers applied to the waveguides and of the frequencies applied to the waveguides, at the times corresponding to the times of part a).

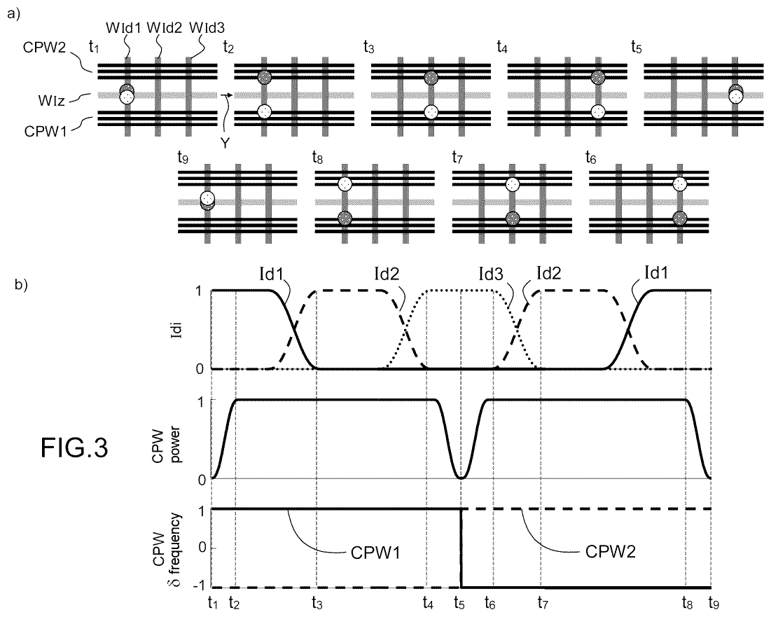

FIG. 4 (already described) illustrates a second example of the topology of an atom chip according to the prior art.

FIG. 5 (already described) illustrates the movement made by atoms taking the path illustrated in FIG. 4.

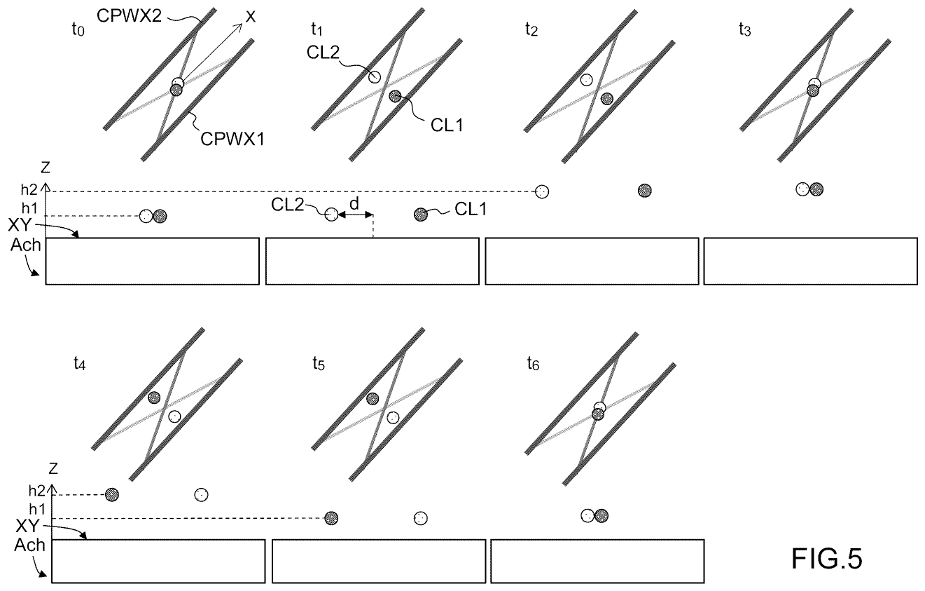

FIG. 6 (already described) illustrates one example of a matrix-array atom chip according to the prior art.

FIG. 7 illustrates two paths being traced in inverse directions according to the invention by clouds of atoms.

FIG. 8 illustrates the interferometric inertial ultracold-atom sensor according to the invention.

FIG. 9 illustrates a first way of producing two paths TZ1 and TZ2 contained in the XY-plane (measurement of Oz) traced in inverse directions by each cloud in an internal state |a> or |b>, in which the clouds are moved with conductive wires.

FIG. 10 illustrates a second way of producing two paths TZ1 and TZ2 contained in the XY-plane (measurement of Wz) traced in inverse directions by each cloud in an internal state |a> or |b>, in which the clouds are moved by applying DC currents to conductive wires.

FIG. 11 illustrates a third way of producing two paths TZ1 and TZ2 contained in the XY-plane (measurement of Wz) traced in inverse directions by each cloud in an internal state |a> or |b>, in which the clouds are moved by applying DC currents to conductive wires.

FIG. 12 illustrates a fourth way of producing two paths TZ1 and TZ2 contained in the XY-plane (measurement of Wz) traced in inverse directions by each cloud in an internal state |a> or |b>, in which the clouds are moved by applying microwave signals to waveguides.

FIG. 13 illustrates a fifth way of producing two paths TZ1 and TZ2 contained in the XY-plane (measurement of Wz) traced in inverse directions by each cloud in an internal state |a> or |b>, in which the clouds are moved by applying microwave signals to waveguides.

FIG. 14 illustrates a sixth way of producing two paths TZ1 and TZ2 contained in the XY-plane (measurement of Wz) traced in inverse directions by each cloud in an internal state |a> or |b>, in which the clouds are moved by applying microwave signals to waveguides.

### DETAILED DESCRIPTION

The idea of the invention is to use two elementary sensors particularly configured to eliminate measurement bias.

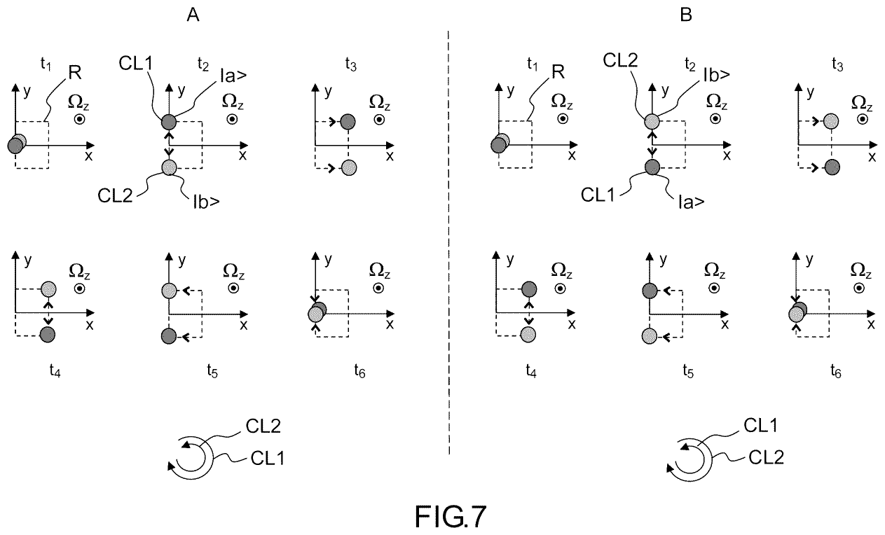

Formula (1) given above corresponds to one direction of travel of the cloud of atoms CL1 (and CL2 of opposite direction) over a path such as described above. By way of illustration, the path is considered to be a rectangle R traced in a clockwise direction by CL1 (state |a>) and in an anti-clockwise direction by CL2 (state |b>), such as illustrated in part A of FIG. 7.

For a gyrometer, the sign of the phase shift induced by the presence of a rotation during the interferometry phase depends on the way in which the two clouds of atoms trace a given geometric path. The sign of the phase shift depends on the direction of travel of each of the states with respect to the direction of rotation.

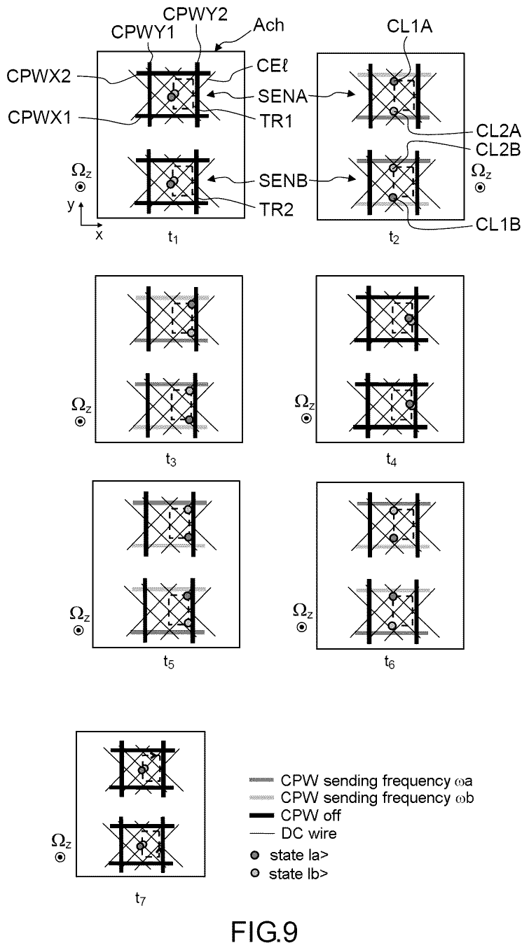

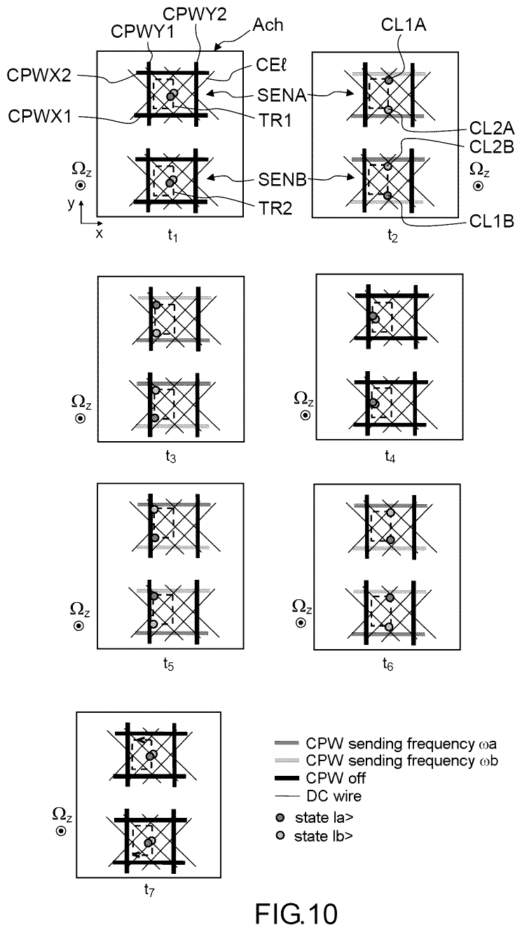

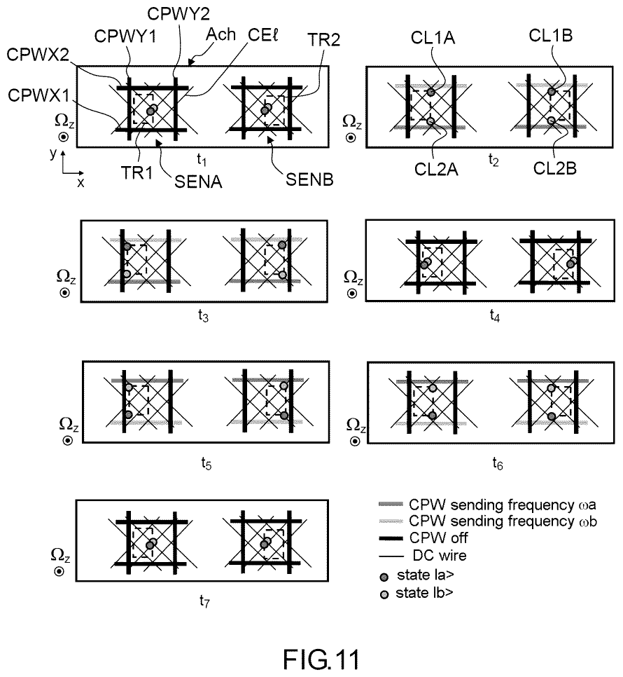

Either everything happens in the same direction (to the right as in FIG. 9, or to the left as in FIG. 10), and then the direction of separation must be inverted. Or one departs to the right, and the other to the left, and the direction is the same (FIG. 11).

Consider two cold-atom gyrometers placed on the same chip with the traps separated/moved using a movable trapping potential, each being oriented so that it is sensitive to rotations about the same axis (e.g. z-axis). This means that the two paths followed by the clouds are placed in the same plane. If the direction of travel of the atomic states used in these sensors is opposite, each gyrometer will accumulate the same phase shift though the sign of the phase shift will differ. By making these two measurements simultaneously, it is possible to eliminate the presence of measurement bias, as explained below.

Thus starting with part A of FIG. 7, if the directions of propagation of the atoms of each state are inverted (i.e. the path of state |a> describes the rectangle in the anti-clockwise direction, and state |b> describes the same path but in the clockwise direction) as illustrated in part B of FIG. 7, then this phase shift changes sign.

Let φ_{tot-S1} be the phase accumulated during the interferometric sequence corresponding to part A of FIG. 7, and φ_{tot-S2} be the phase accumulated during the interferometric sequence corresponding to part B of FIG. 7. Rewriting formula (1) gives:

$${φ}_{tot\_S 1} = {φ}_{c l o c k} + {φ}_{rot} = ( ω - {ω}_{a b} + \frac{4 m N {Ω}_{z} \cdot A}{ℏ} ) {T}_{R} \qquad ( 2 A )$$

$${φ}_{tot\_S 2} = {φ}_{c l o c k -} {φ}_{rot} = ( ω - {ω}_{a b} - \frac{4 m N {Ω}_{z} \cdot A}{ℏ} ) {T}_{R} \qquad ( 2 B )$$

Assuming that the measurement is affected by a bias, it may be stated that:

$$\begin{matrix}{φ}_{tot\_S 1} = {φ}_{c l o c k} + {φ}_{rot} + {φ}_{b i a s} \\ {φ}_{tot\_S 2} = {φ}_{clock -} {φ}_{rot} + {φ}_{b i a s}\end{matrix}$$

with φ_{bias} an additional phase due to the bias present in any measure (so-called additive bias).

If a (not negligible) bias is present, determining φ_{tot_S1}−φ_{tot_S2} allows it to be eliminated:

$${φ}_{rot} = \frac{1}{2} ( {φ}_{tot\_S 1} - {φ}_{tot\_S 2} ) \qquad ( 3 )$$

In order to make a measurement allowing bias to be removed, it is necessary to carry out two interferometric sequences in parallel with two sensors on the same chip.

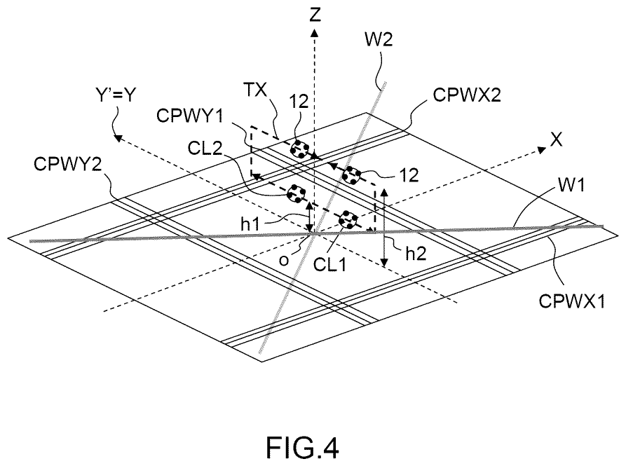

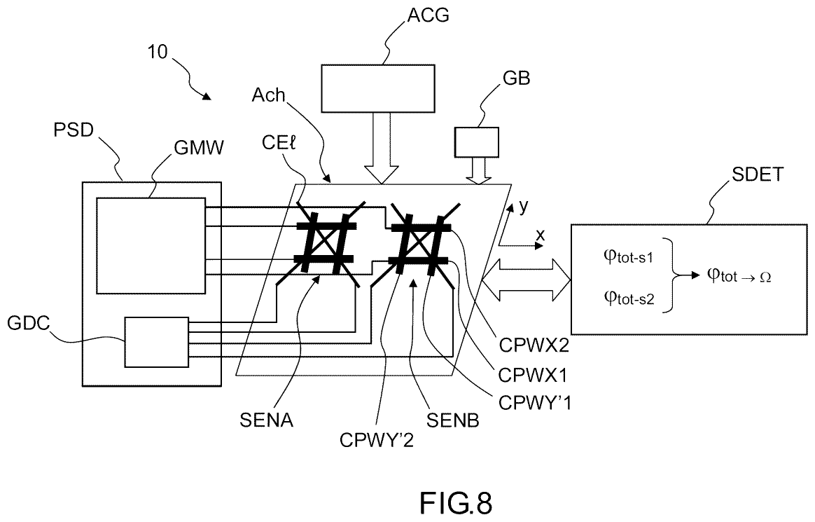

The interferometric inertial ultracold-atom sensor 10 according to the invention uses this property and is illustrated in FIG. 8. It comprises an atom chip ACh placed in a vacuum chamber, comprising an XY-plane, called the measurement plane, normal to the Z-axis. The chip comprises at least one set of a first elementary sensor SENA and a second elementary sensor SENB. Each elementary sensor comprises at least one first pair of waveguides (CPWX1, CPWX2) parallel to each other and at least one second pair of waveguides (CPWY′1, CPWY′2) parallel to each other and secant with the first pair. The intersection of the two pairs defines a parallelogram such as illustrated in FIG. 4. The atom chip also comprises a group of one or more conductive elements CE|.

The sensor further comprises an atom-generating device ACG configured to generate an initial cloud of ultracold atoms associated with the first elementary sensor SENA and an initial cloud of ultracold atoms associated with the second elementary sensor SENB. The initial clouds are located close to said XY-plane of the chip. The sensor also comprises a generator GB for generating a uniform magnetic field Bc and a power-supplying device PSD. The power-supplying device comprises at least one microwave generator GMW configured to apply microwave signals to the waveguides and at least one generator of DC current configured to apply DC currents to the conductive elements. The magnetic-field generator GB and the power-supplying device PSD are configured to apply the magnetic field Bc, the DC currents and the microwave signals in a predetermined sequence.

The arrangement of the group of one or more conductive elements and the predetermined sequence are configured, when each sensor is implemented, to carry out the various steps described above on the clouds.

It is first a question of generating an initial potential Vini for trapping said initial cloud of ultracold atoms, then of spatially separating the initial cloud into a first cloud of ultracold atoms (CL1A for SENA and CL1B for SENB) in a first internal state and a second cloud of ultracold atoms (CL2A for SENA and CL2B for SENB) in a second internal state, by forming a first ultracold-atom trap (T1A for SENA and T1B for SENB) and a second ultracold-atom trap (T2A for SENA and T2B for SENB) respectively.

Next the traps are moved along a closed path parallel or perpendicular to XY, said closed path being traced in one direction by the first cloud of ultracold atoms and in the opposite direction by the second cloud of ultracold atoms.

The arrangement of the group of one or more conductive elements and the predetermined sequence are further configured so that the path TR1A associated with the first elementary sensor and the path TR2A associated with the second elementary sensor are identical and traced simultaneously and in inverse directions by the clouds of ultracold atoms associated with a given internal state. It is a question of applying the principle of two paths traced in inverse directions that is illustrated in FIG. 7.

The sensor further comprises a detecting system SDET configured to measure at least a first phase φ_{tot_S1} of the first elementary sensor and a second phase φ_{tot_S2} of the second elementary sensor. The velocity of rotation is determined from a difference between the first and second phases (property expressed with formula (2)). During implementation of the sensor according to the invention, a dual simultaneous measurement of the same parameter, the phase accumulated during the interferometric sequence, is therefore made.

Using the interferometer property expressed by formulae (2A) (2B) and (3), the velocity of rotation thus determined is corrected for “additive” bias, which affects each measurement identically. This reduction in measurement bias leads to reduced measurement uncertainty for the gyrometer according to the invention, i.e., improved sensitivity, this allowing longer inertial navigation times to be obtained.

The sensor according to the invention is compatible with any atom-chip geometry comprising two pairs of microwave guides making it possible to generate what are referred to as “dressed” traps (see the prior art), i.e. to generate a trapping potential, and these traps to be moved selectively depending on the internal states along a closed path.

Thus, the conductive elements CE| of the chip may be arranged in various ways. What matters is generation of a trapping potential resulting from combination of DC fields generated by conductive elements passing DC currents and of microwave fields generated by waveguides passing microwave signals, this trapping potential being able to be moved to produce the closed path.

For example, the sensor according to the invention is compatible with all the chip geometries described in the prior art, associated with the various addressing modes, i.e., with particular sequences of application of the magnetic field, of the DC currents and of the microwave fields.

Typically according to the prior art:

The initial trapping potential is generated by applying DC currents to the conductive elements, typically two wires that cross at point O, or two strips that cross, or a flared wire, etc.

The two traps T1 and T2 are separated by applying microwave signals to the various waveguides.

The movement of the traps, which is achieved by moving the minimum of the trapping potential, results:
either from application of DC currents to other conductive wires (US2018/0352642), to the same wires and/or from application of a different magnetic field (US2023/0178262),
or from application of microwave signals to the guides in a particular sequence of turn on and turn off of the guides with signals of various frequencies, in association with a particular conductive-element geometry: flared wire (US2022/0397396); two secant strips (US2022/0397397).

Specifically, either the minimum of the DC magnetic field (resulting from the DC current in the wires and from the uniform magnetic field) is moved, this moving the minimum of the trap resulting from the combination of the DC magnetic field and MW field (resulting from passage of the microwave signals through the waveguides), or the DC magnetic field is fixed and the MW magnetic field is changed, this moving the trap resulting from the combination of the DC magnetic field and MW field.

According to another embodiment, once the clouds have been separated, the microwave signals applied to the waveguides are replaced by DC currents. This embodiment is described in the context of application to gyrometers in document FR2306475 (not yet published on the filing date). In this case, the power-supplying device PSD is further configured to apply DC currents to the waveguides. This replacement allows measurement noise to be decreased.

The sensor according to the invention is thus independent of the geometry of the atom chip and the method used to selectively separate/move the traps. The chip may employ another conductive-element geometry associated with waveguides not described in the aforementioned documents, and additional waveguides. The implementation of the sensor may use separating/moving methods (sequences) making it possible to produce a trapping potential that is movable (i.e. the minimum of which can be moved) other than those described in the aforementioned documents.

Non-limiting examples of embodiment of the sensor according to the invention will now be described.

FIGS. 9 to 16 illustrate various ways of producing two paths TR1 and TR2 contained in the XY-plane (measurement of Ω_{z}) traced in inverse directions by each cloud in an internal state |a> or |b>. The position of the various clouds has been shown for a series of characteristic times t₁ to t₇: t₁ starting situation; t₂ separation; t₃ movement; t₄ recombination; t₅ separation (in the opposite direction); t₆ movement; t₇ recombination. The hue or texture of a guide illustrates its state, i.e. whether it is “off” (no signal applied; black) or “on” (signal applied; various shades of grey). The direction of the arrow on the paths at the last time t₇ illustrates the direction in which the paths are traced by the cloud in the internal state |a> (dark grey). Other paths in the XY-plane and in other (XZ- and YZ-) planes may be obtained non-limitingly with the geometries and sequences described in the prior art.

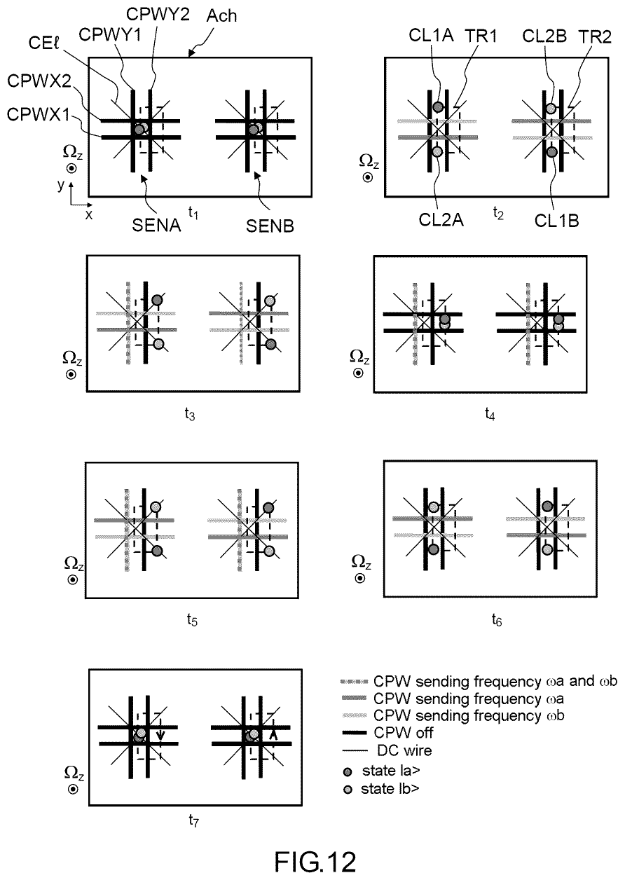

FIGS. 9 to 11 illustrate the case in which the traps are moved by applying DC currents to two crossing points. FIGS. 12 to 14 illustrate the case in which the traps are moved via a “repelling” effect, by applying a “sum” signal to one of the guides of the pair not used for separation. In all the figures, the traps move horizontally along the X-axis and are separated vertically along Y by applying a microwave field to the guides along X, i.e. to CPWX1 and CPWX2. In these examples Y′=Y and the first pair and the second pair of waveguides are perpendicular to each other in each sensor of the set.

In FIG. 9 the direction of separation of the two states is opposite for the two paths (cloud CL1A in state |a> of SENA upwards, cloud CL1B in state |a> of SENB downwards) and each pair of clouds associated with one elementary sensor moves in the same direction, here rightwards.

In FIG. 10 the direction of separation of the two states is opposite for the two paths (cloud CL1A in state |a> of SENA upwards, cloud CL1B in state |a> of SENB downwards) and each pair of clouds associated with one elementary sensor moves in the same direction, here leftwards.

In FIG. 11 the direction of separation of the two states is identical for both paths (cloud CL1A in state |a> of SENA and cloud CL1B in state |a> of SENB upwards) and the two pairs of clouds associated with the two elementary sensors move in an opposite direction, leftwards in SENA (clouds CL1A and CL2A) and rightwards in SENB (clouds CL1B and CL2B).

In FIG. 12 the direction of separation of the two states is opposite for the two paths (cloud CL1A in state |a> of SENA upwards, cloud CL1B in state |a> of SENB downwards) and each pair of clouds associated with one elementary sensor moves in the same direction, here rightwards. For this purpose, a “sum” signal is applied to the guide along Y on the side opposite the movement, i.e. on the left-hand side.

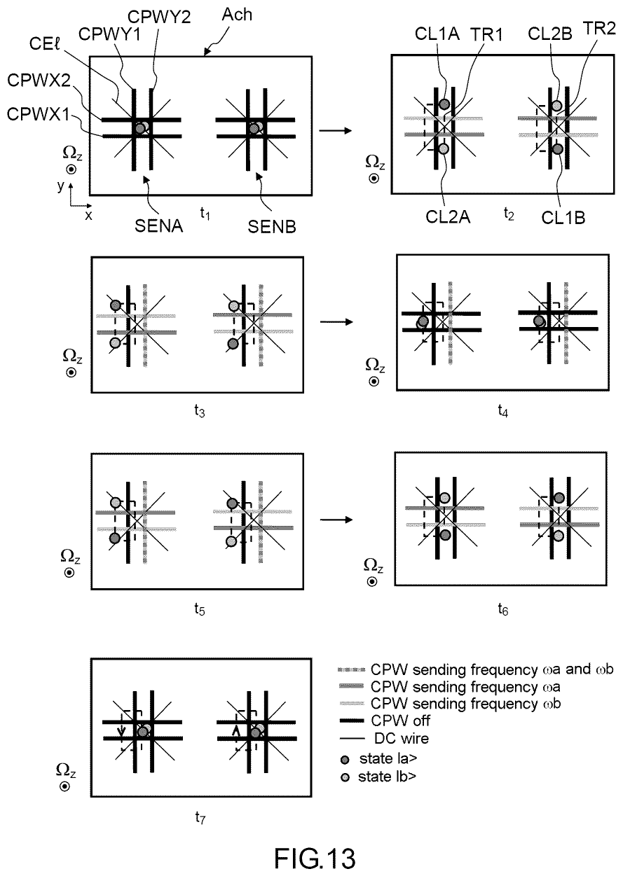

In FIG. 13 the direction of separation of the two states is opposite for the two paths (cloud CL1A in state |a> of SENA upwards, cloud CL1B in state |a> of SENB downwards) and each pair of clouds associated with one elementary sensor moves in the same direction, here leftwards. For this purpose, a “sum” signal is applied to the guide along Y on the side opposite the movement, i.e. on the right-hand side.

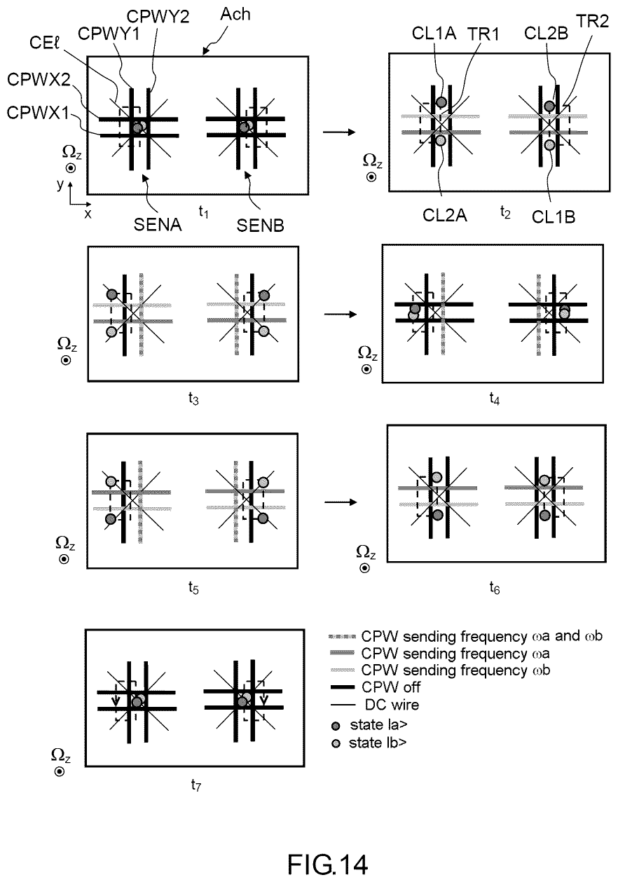

In FIG. 14 the direction of separation of the two states is identical for both paths (cloud CL1A in state |a> of SENA and cloud CL1B in state |a> of SENB upwards) and the pairs of clouds associated with the two elementary sensors move in an opposite direction, leftwards in SENA and rightwards in SENB. For this purpose, a “sum” signal is applied to the guide along Y on the right-hand side in SENA and to the guide along Y on the left-hand side in SENB.

According to one embodiment, the sensor according to the invention comprises at least three sets configured to make a measurement of rotation about three orthogonal axes, respectively. For this purpose, in each set, the first pair and the second pair of waveguides are perpendicular to each other. For example, the first set is configured to measure Ωz with generation of a path perpendicular to Z, the second set is configured to measure Ωx with generation of a path perpendicular to X, and the third set is configured to measure Ωy with generation of a path perpendicular to Y (specifically Y′=Y).

According to one embodiment, the various sets are organized into a matrix array. According to one embodiment, the atom chip of the sensor according to the invention has a matrix-array structure the pixels of which define potential elementary sensors. A set according to the invention comprising two sensors SENA and SENB corresponds to two pixels of the matrix array.

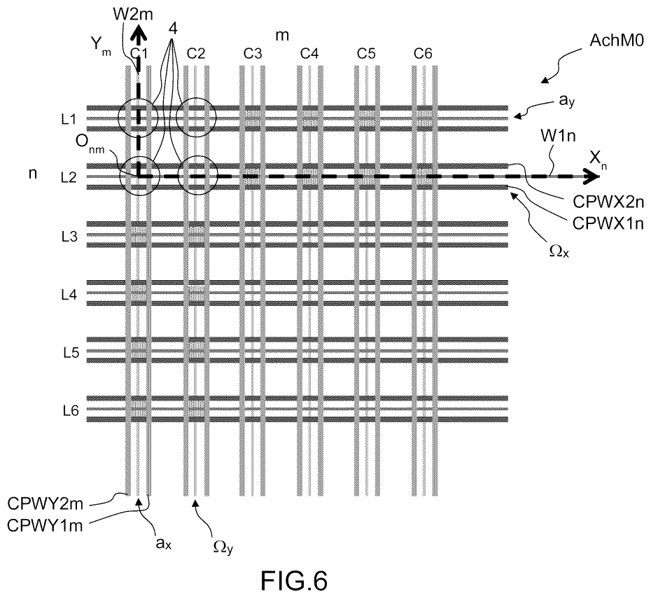

The structure of the matrix array is for example such as described in the prior art. According to one embodiment, it is the arrangement of the pairs of waveguides that defines the columns and rows of the matrix array, as illustrated in FIG. 6. According to another embodiment, it is the arrangement of the conductive elements (wires/strips/flared wires) that defines the rows and columns, the pairs of guides typically being along the diagonals of the matrix array (see examples in the document US2023/0178262).

In order to optimize the measurements, according to one embodiment, sets of a first and second elementary sensor have a pair of waveguides in common or at least one conductive element in common. It is thus possible to use the same sequence applied to the guides or the elements in common to measure the two phases according to the invention.

Typically, in the figures illustrating various examples, it may be seen that in certain configurations the waveguides along X may be common to the two sensors (FIGS. 11 and 14), or the waveguides along Y may be common (FIGS. 9, 10, 11, 12 and 13), this optimizing the matrix-array arrangement.

The invention also relates to an inertial measurement unit on a matrix-array atom chip comprising at least three sensors of gyrometer type according to the invention, which sensors are configured to make a measurement of velocity of rotation about three orthogonal axes respectively, the matrix-array atom chip further comprising pixels configured to make at least one clock measurement and pixels configured to make a measurement of acceleration along at least two orthogonal axes.

According to another aspect, the invention relates to a method for measuring a velocity of rotation using an interferometric inertial ultracold-atom sensor 10 comprising an atom chip ACh placed in a vacuum chamber, comprising an XY-plane, called the measurement plane, normal to a Z-axis, and comprising at least one set of a first and second elementary sensor (SENA, SENB), each elementary sensor comprising:
at least one first pair of waveguides (CPWX1, CPWX2) parallel to each other and at least one second pair of waveguides (CPWY′1, CPWY′2) parallel to each other and secant with the first pair,
a group of one or more conductive elements,

The method comprises a first step A consisting in generating an initial cloud of ultracold atoms associated with the first elementary sensor SENA and an initial cloud of ultracold atoms associated with the second elementary sensor SENB, the initial clouds being located close to said XY-plane of said chip. In a step B, a uniform magnetic field is generated and in a step C an initial potential Vini for trapping the initial cloud of ultracold atoms is generated.

Next, in each sensor, in a step D, the first internal state |a> and the second internal state |b> are initialized via a first π/2 pulse.

Next, in each sensor, in a step E, the initial cloud is spatially separated into a first cloud (CL1A, CL1B) of atoms in the first internal state and a second cloud (CL2A, CL2B) of ultracold atoms in the second internal state, by forming a first ultracold-atom trap (T1A, T1B) and a second ultracold-atom trap (T2A, T2B), respectively.

Next, in each sensor, in a step F, the traps are moved along a closed path parallel or perpendicular to XY, said closed path being traced in one direction by the first cloud of ultracold atoms and in the opposite direction by the second cloud of ultracold atoms.

Steps B to F are carried out by applying, in a predetermined sequence, a uniform magnetic field in the vicinity of the chip, direct currents to the conductive elements and microwave signals to the waveguides.

The arrangement of the group of one or more conductive elements and said predetermined sequence are further configured so that the path TR1A associated with the first elementary sensor and the path TR2A associated with the second elementary sensor are identical and traced simultaneously and in inverse directions by the clouds of ultracold atoms associated with a given internal state.

In a step G, the first and second internal states are recombined by applying a second π/2 pulse to the ultracold atoms.

Lastly, in a step H, at least a first phase φ_{tot_S1} of the first elementary sensor and a second phase φ_{tot_S2} of the second elementary sensor are measured, the velocity of rotation being determined from a difference between the first and second phases.

According to one embodiment, step C comprises applying DC currents to at least one conductive element.

According to one embodiment, step E comprises applying microwave signals to the first pair of waveguides. According to one embodiment, step F comprises applying microwave signals to at least one waveguide of the second pair.

According to one embodiment, step F comprises applying DC currents to certain conductive elements.

1. An interferometric inertial ultracold-atom sensor of gyrometer type, comprising:
an atom chip (ACh) placed in a vacuum chamber, comprising an XY-plane, called the measurement plane, normal to a Z-axis, and comprising at least one set of a first and a second elementary sensor (SENA, SENB), each elementary sensor comprising:
at least one first pair of waveguides (CPWX1, CPWX2) parallel to each other and at least one second pair of waveguides (CPWY′1, CPWY′2) parallel to each other and secant with the first pair,
a group of one or more conductive elements,
an atom-generating device (ACG) configured to generate an initial cloud of ultracold atoms associated with the first elementary sensor (SENA) and an initial cloud of ultracold atoms associated with the second elementary sensor (SENB), said initial clouds being located close to said XY-plane of said chip,
a generator (GB) for generating a uniform magnetic field (Bc),
a power-supplying device (PSD) comprising at least one microwave generator (GMW) and at least one generator (GDC) of DC current, the power-supplying device being configured to apply microwave signals to said waveguides and DC currents to said conductive elements,
the magnetic-field generator and the power-supplying device being configured to apply the magnetic field, the DC currents and the microwave signals in a predetermined sequence,
an arrangement of said group of one or more conductive elements and said sequence being configured, during implementation of each sensor, to:
i) generate an initial potential (Vini) for trapping said initial cloud of ultracold atoms,
ii) spatially separate the initial cloud into a first cloud (CL1A, CL1B) of ultracold atoms in a first internal state and a second cloud (CL2A, CL2B) of ultracold atoms in a second internal state, by forming a first ultracold-atom trap (T1A, T1B) and a second ultracold-atom trap (T2A, T2B), respectively,
iii) and move said traps along a closed path parallel or perpendicular to XY, said closed path being traced in one direction by the first cloud of ultracold atoms and in the opposite direction by the second cloud of ultracold atoms,
the arrangement of said group of one or more conductive elements of each sensor and said sequence further being configured so that the path (TR1) associated with the first elementary sensor and the path (TR2) associated with the second elementary sensor are identical and traced simultaneously and in inverse directions by the clouds of ultracold atoms associated with a given internal state,
the sensor further comprising a detecting system (SDET) configured to measure at least a first phase (φ_{tot_S1}) of the first elementary sensor and a second phase (φ_{tot_S2}) of the second elementary sensor, with a velocity of rotation being determined from a difference between the first and second phases.

2. The sensor according to claim 1, wherein the power-supplying device (PSD) is further configured to apply DC currents to said waveguides.

3. The sensor according to claim 1, comprising at least three sets configured to make a measurement of rotation about three orthogonal axes, respectively.

4. The sensor according to claim 1, wherein the atom chip has a matrix-array structure, the pixels of which define potential elementary sensors, a set comprising two pixels of the matrix array.

5. The sensor according to claim 4, wherein sets of a first and second elementary sensor have a pair of waveguides in common or at least one conductive element in common.

6. An inertial measurement unit comprising at least three sensors of gyrometer type according to claim 4, which sensors are configured to make a measurement of velocity of rotation about three orthogonal axes respectively, the matrix-array atom chip further comprising pixels configured to make at least one clock measurement and pixels configured to make a measurement of acceleration along at least two orthogonal axes.

7. A method for measuring a velocity of rotation using an interferometric inertial ultracold-atom sensor comprising an atom chip (ACh) placed in a vacuum chamber, comprising an XY-plane, called the measurement plane, normal to a Z-axis, and comprising at least one set of a first and second elementary sensor (SENA, SENB), each elementary sensor comprising:
at least one first pair of waveguides (CPWX1, CPWX2) parallel to each other and at least one second pair of waveguides (CPWY′1, CPWY′2) parallel to each other and secant with the first pair,
a group of one or more conductive elements,
the method comprising the following steps:
A. generating an initial cloud of ultracold atoms associated with the first elementary sensor (SENA) and an initial cloud of ultracold atoms associated with the second elementary sensor (SENB), said initial clouds being located close to said XY-plane of said chip,
B. generating a uniform magnetic field,
C. generating an initial potential (Vini) for trapping said initial cloud of ultracold atoms,
D. for each sensor, initializing a first internal state and a second internal state via a first π/2 pulse,
E. for each sensor, spatially separating the initial cloud into a first cloud (CL1A, CL1B) of ultracold atoms in the first internal state and into a second cloud (CL2A, CL2B) of ultracold atoms in the second internal state, by forming a first ultracold-atom trap (T1A, T1B) and a second ultracold-atom trap (T2A, T2B), respectively,
F. for each sensor, moving said traps along a closed path parallel or perpendicular to XY, said closed path being traced in one direction by the first cloud of ultracold atoms and in the opposite direction by the second cloud of ultracold atoms,
steps B to F being carried out by applying, in a predetermined sequence, a uniform magnetic field, DC currents to said conductive elements and microwave signals (I_{MW}) to said waveguides,
the arrangement of said group of elements of one or more conductive elements and said predetermined sequence further being configured so that the path (TR1A) associated with the first elementary sensor and the path (TR2A) associated with the second elementary sensor are identical and traced simultaneously and in inverse directions by the clouds of ultracold atoms associated with a given internal state,
G. recombining said first and second internal states by applying a second π/2 pulse to said ultracold atoms,
H. measuring at least a first phase (φ_{tot_S1}) of the first elementary sensor and a second phase (φ_{tot_S2}) of the second elementary sensor, a velocity of rotation being determined from a difference between the first and second phases.

8. The method according to claim 7, wherein step C comprises applying DC currents to at least one conductive element.

9. The method according to claim 7, wherein step E comprises applying microwave signals to the first pair of waveguides.

10. The method according to claim 9, wherein step F comprises applying microwave signals to at least one waveguide of the second pair.

11. The method according to claim 7, wherein step F comprises applying DC currents to certain conductive elements.
